(19) United States
(12) Patent Application Publication
(10) Pub. No.: US 2007/0115124 A1
(43) Pub. Date: May 24, 2007

(54) Determining a state for object identified by an RFID tag

(76) Inventors: Cyril Brignone, Mountain View, CA (US); Salil Pradhan, San Jose, CA (US); Craig Sayers, Menlo Park, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/284,022

(22) Filed: Nov. 21, 2005

(51) Int. Cl. G08B 13/14; G06Q 30/00; G08B 5/22; G06F 7/00

(52) U.S. Cl. 340/572.1; 340/825.49; 235/385; 700/213

(57) ABSTRACT

Information from an object having an RFID tag is received and state information about the object is received from a sensing device. A state is determined for the object using the information from the tag and the sensing device, and the state is assigned to the object.

### BACKGROUND

Radio frequency identification device (RFID) systems are widely used for tracking and other applications in many different types of industries. A typical RFID system includes RFID tags and an RFID reader that reads information from the RFID tags. For example, the RFID reader includes a transmitter that outputs radio frequency (RF) signals through an antenna to create an electromagnetic field that enables the tags to return an RF signal carrying the information stored in the tag, which is received by the reader. Some types of conventional tags are “passive” tags, such as tags without an internal power source that may be energized by the electromagnetic field generated by the reader, and “active tags”, such as tags with an internal power source.

Many RFID systems use tags to track various goods, products, and inventory. For example, a tag is attached to a palette of goods. The palette of goods is tracked using readers at various points in the supply chain. These type of RFID tracking systems are still evolving, and the potential of this technology is still yet to be explored.

The conventional RFID tracking systems only provide a static record indicating that a particular tag was read and possibly the time it was read. Conventional systems may also read additional information, other than identification information, stored on an RFID tag. However, these systems generally lack the ability to determine additional dynamic information about the tag and the associated products carrying the tag. In certain situations, products may be unintentionally left behind as the products are moving through the supply chain, because the products were temporarily moved from a designated location or the products were taken out of a truck temporarily and never put back in the truck. This can cause delays in getting products to consumers or may result in products being damaged or destroyed for perishable products. Also, typical RFID systems lack the ability to determine whether products were temporarily moved without being replaced. For example, first and second palettes are in a truck, and the truck docks at a warehouse to unload the second palette, which is destined for that warehouse. The first palette is unloaded from the truck into the warehouse in order to access and unload the second palette into the warehouse. A reader reads both palettes in the warehouse and a tracking system records both palettes as being unloaded in the warehouse. However, the first palette is not destined for that warehouse and is loaded back into the truck, but the tracking system is unable to determine that the first palette has been reloaded into the truck and is destined for a second warehouse. Thus, the tracking system incorrectly shows both palettes in the first warehouse. This creates inconsistencies that can result in accurate billing and misplaced inventory. Furthermore, resources are wasted to find and correct the inconsistencies in the tracking system.

### BRIEF DESCRIPTION OF THE DRAWINGS

Various features of the embodiments can be more fully appreciated, as the same become better understood with reference to the following detailed description of the embodiments when considered in connection with the accompanying figures.

FIG. 1 illustrates a system, according to an embodiment;

FIG. 2A illustrates a physical view of a system, according to an embodiment;

FIG. 2B illustrates a virtual model of the system shown in FIG. 2A, according to an embodiment;

FIG. 3 illustrate a flow chart of a method, according to an embodiment; and

FIG. 4 illustrate a computing platform that may be used in the embodiments.

### DETAILED DESCRIPTION

For simplicity and illustrative purposes, the principles of the embodiments are described. Moreover, in the following detailed description, references are made to the accompanying figures, which illustrate specific embodiments. Changes may be made to the embodiments without departing from the spirit and scope of the embodiments.

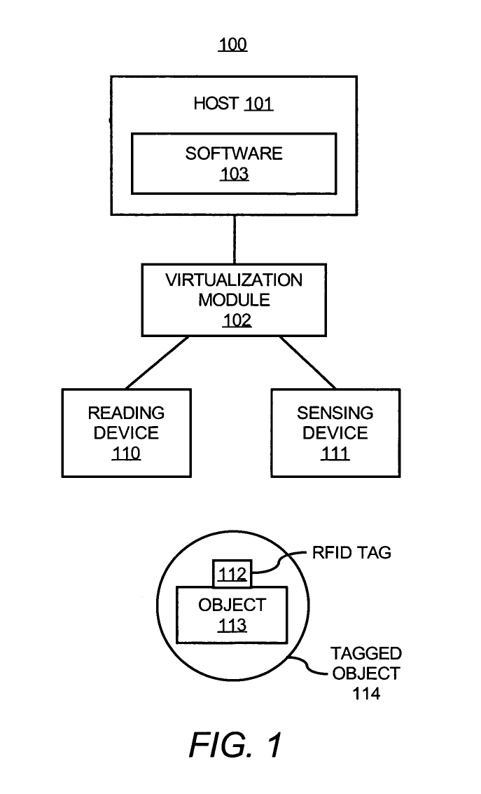

FIG. 1 illustrates a system 100 according to an embodiment. The system 100 includes a host 101, software 103, a virtualization module 102, at least one reading device 110, and at least one sensing device 111. FIG. 1 also illustrates an RFID tagged object 114, referred to as tagged object 114, that may comprise an object 113 and an RFID tag 112, referred to as tag 112, associated with the object 113. For example, the tag 112 is attached or connected to the object 113. The RFID tag 112 may also alternatively be attached to a device which contains a plurality of objects 113. For example, the RFID tag 112 may be attached to a pallet or box, which holds a plurality of individual objects 113.

The reading device 110 may read identification information contained in the RFID tag 112. For example, the identification information includes a unique identifier identifying the object 113. The reading device 110 may read the identification information, as well as other information contained in the tag 112. In one embodiment, the reading device 110 may read product information about the object 113 contained in the tag 112, including one or more of an electronic product code (EPC), history, quantity, and quality information, if such information is stored in the tag 112. For example, if the tag is on a palette of goods, the tag may identify the previous locations that the palette visited in a supply chain and the quantity of goods on the palette. If the goods have been through a testing process, the results of the tests may be stored on the RFID tags 112. Other types of information may also be stored in the tag 112 depending on the type of tag, the amount of memory in the tag 112 and other factors.

The sensing device 111 senses state information. The sensing device 111 may include, but is not limited to, a camera system, motion detectors, infra red (IR) systems, pressure sensing system, or other known types of sensing devices. State information may be obtained by the sensing device 111 and may include information captured, measured, or otherwise detected by the sensing device 111. Examples of state information may include video images, an indication of motion, an indication of whether an IR beam has been blocked, pressure measurements or detection of pressure, time-stamps, and other sensed information. For example, the sensing device 111 may include two sets of adjacent IR devices. These sensing devices may detect when IR beams are blocked by the object 113 and the times when the IR beams were blocked. This information is state information and may be used to determine the state of the object 113. For example, the order in which the IR beams are blocked or the times they are blocked may be used to determine the direction the object 113 is moving.

One example of the state of an object is the direction of movement of the object. Other examples of states determined from state information include determining the size of an object, determining whether an object is a good, or determining whether an object is a human. These are examples and it will be apparent to one of ordinary skill in the art that other states may be determined using the embodiments described herein.

FIG. 1 illustrates only a single reading device 110 and sensing device 111. However, embodiments may include multiple reading devices and multiple sensing devices. Reading devices may read a wide variety of different information contained in RFID tags. Similarly, multiple sensing devices may be used in different embodiments to sense a variety of different states.

The virtualization module 102 may be software or hardware, or a combination of software and hardware. The virtualization module 102 may receive the information obtained from the reading device 110 and may receive the state information obtained from the sensing device 111. The virtualization module 102 uses the state information obtained from the sensing device 111 to determine a state of the object 113. In the example above, the sensing device 111 includes two sets of IR devices that sense when IR beams are blocked. Instead of IR devices, pressure sensors, cameras, or a variety other devices may be used. IR devices may also be used in combination with pressure sensing devices, camera systems, or other devices. The virtualization module 102 may use the state information received from the sensing devices 111, such as the times when the beams were blocked, to determine the state of the object 113, which in this case, is the direction of movement. For example, if the state information indicates that one IR beam was blocked before the adjacent IR beam, the virtualization module 102 may determine the object 113 was moving in a first direction.

The virtualization module 102 may also assign the determined state to the object 113, the RFID tag 112, or the tagged object 114. For example, the sensing device 111 may sense state information associated with an object 113. This state information is received by the virtualization module 102, which determines the state of the object 113. The virtualization module 102 may then assign or correlate the state of the object with the RFID tag 112 attached to the object 113. Assigning the state may include assigning the state of the object 113 to the tag ID or serial number of the tag 112 read by the reading device 110. The virtualization module 102 may then convert the state to a predetermined value, which may be represented using a virtual model.

In some embodiments, the virtualization module 102 may passively wait for data from the reading device 110 and sensing device 111. However, in other embodiments, the virtualization module 102 may actively query one or both devices for data. In the embodiment illustrated in FIG. 1, the virtualization module 102 is depicted as being separate from the host 101. The virtualization module 102 may be located in a remote physical location from the host 101. For example, the virtualization module 102 may reside on the reading device 110, on the sensing device 111, or in any separate computing system, such as the host 101. However, the virtualization module 102 may also be in physical connection with the host 101 or incorporated into the host 101. In some embodiments the virtualization module 102 may comprise multiple pieces of software. These different software components may reside on the same hardware or may be spread amongst multiple pieces of hardware.

The host 101 may be a computing system. The host 101 may run software 103 for processing various forms of information. For example, the software 103 may include one or more applications for monitoring and tracking inventory using data read from tagged objects, such as the tagged object 114. The host 101 may also contain hardware and software unrelated to the embodiments described herein. In one embodiment the host 101 may be a data center which processes a wide variety of information.

In one example, the host 101 may receive the state for the object 113, which has been determined by virtualization module 102. The software 103 contained in the host 101 may also receive the state from the virtualization module 102. For example, the software 103 includes inventory and tracking software, and the inventory and tracking software receives a state for the object 113 comprising the determined direction of movement of the tagged object 114. The virtualization module 102 may convert the state to a predetermined value understood by the inventory and tracking software, and the inventory and tracking software may use the predetermined value to track inventory, such as monitoring whether the tagged object 114 has entered or exited a warehouse.

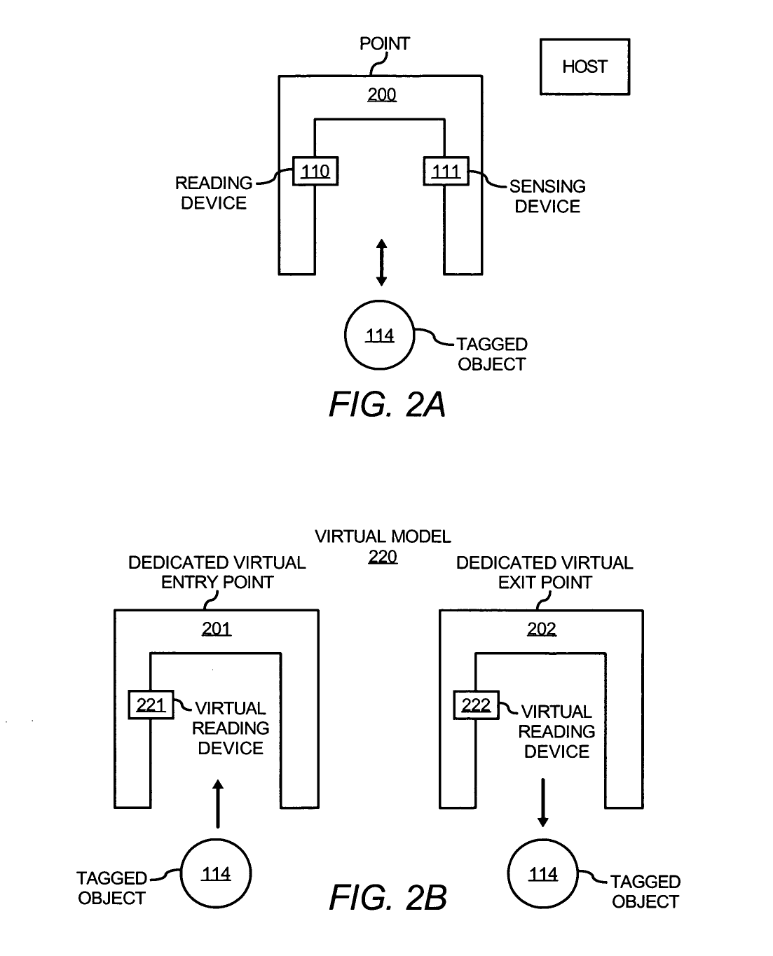

FIG. 2A depicts a physical view of one embodiment wherein the reading device 110 and the sensing device 111 are configured to monitor a single physical point 200. The point 200 may be any location where RFID tagged objects 114 may pass in multiple directions and may be read or detected by the reading device 110 and sensing device 111. For simplicity, the single physical point 200 in FIG. 2A is represented as a doorway. However, the single point 200 may be any point or location where RFID tagged objects may pass and be read or detected by the reading device 110 and sensing device 111. For example, the point 200 may include, but is not limited to, any entry or exit point such as doorways, ports, rail stations, airports, weigh stations, assembly line stations, gates, etc.

The virtualization module 102 is operable to receive the information obtained from the reading device 110 and the sensing device 111, and determine a state of an object, such as the object 113, where the state may then be represented using a virtual model 220, shown in FIG. 2B. The virtual model 220 includes virtual points 201 and 202. The virtual points 201 and 202 include virtual reading devices 221 and 222. In this example, the virtual point 201 represents a dedicated entry point, and the virtual point 202 represents a dedicated exit point. The dedicated entry point means that, in the virtual entry point 201, objects may only pass in one direction. For example, the dedicated virtual entry point 201 only represents tagged objects entering a doorway. Similarly, the dedicated exit point means that, in the virtual exit point 202, tagged objects only pass in the opposite direction of the dedicated entry point 201. For example, the dedicated virtual exit point 202 only represents objects exiting the doorway.

The virtualization module 102 uses the data from the reading device 110 and the state information from the sensing device 111 in the physical environment, which is shown in FIG. 2A, to determine a state of an object, whereby the state may then be converted into predetermined values represented by the virtual model 220 shown in FIG. 2B. For example, the tagged object 114 in FIG. 2A is read by the reading device 110 and detected or sensed by the sensing device 111. The reading device 110 reads the tag 112 of the tagged object 114 shown in FIG. 2A and the information is sent to the virtualization module 102. The virtualization module 102 may then query the sensor 111 for state information associated with the tagged object 114, which was just read by the reading device 110.

In one example, the state information from the sensing device 111 may be associated with determining a direction of movement, such as the times IR beams were broken. The virtualization module 102 determines the state of the tagged object 114, from this information. The state may be that the tagged object 114 is either entering or exiting the point 200, whereby entering and exiting are two opposite directions of movement. If the tagged object 114 is determined to be entering the point 200, then the state is converted to the predetermined value “Entry” for the tagged object 114 at the time the tagged object is read or sensed. The “Entry” state, for example, is the representation shown in FIG. 2B as the tagged object 114 entering the dedicated virtual entry point 201. An “Exit” predetermined value associated with a state comprising the opposite direction of movement would be represented as the tagged object 114 exiting the dedicated virtual exit point 202. The virtualization module 102 may determine the state of a tagged object 114 and also assign the state to the tagged object 114. The state may then be received or stored in the host 101 or in another device. In one example, the state is assigned to the tag ID for the tag 112 associated with the object 113 and stored with the tag ID. The state may change and a new state may then be stored. Also, the predetermined value may be assigned to the object and stored with the tag ID.

As described above, the virtualization module 102 may convert the state into a predetermined value. In the example above, the predetermined values are “Entry” and “Exit”. The predetermined values are values or representations that are understood by the software 103, which may be software for monitoring tagged objects. The predetermined values may also be values that can be processed more quickly and accurately by the software 103. “Entry” and “Exit” are examples of predetermined values, and it will be apparent to one of ordinary skill in the art that other predetermined values may be determined from the state as needed by the software 103 or the host 101, using the determined state for one or more applications, such as tracking and monitoring. For example, other predetermined values may include “Exit left,” “Exit right,” “Entry East,” or “Entry west.”

In certain instances, the system or software, such as the software 103 shown in FIG. 1 running in the host 101, may only understand predetermined values about a tagged object 114. The predetermined value, for example, is the conversion of a particular state of the tagged object 114 determined by the virtualization module 102. For example, some systems may lack the capacity to understand and/or process the raw information taken directly from the reading device 110 and the sensing device 111. Raw information refers to information read by the reading device 110 and sensed by the sensing device 111, which has not been further altered or processed. Such systems may only be able to understand and/or process information from reading device 110 and sensing device 111 after this information has been converted into a different format.

In other embodiments, the system receiving the information from the virtualization module 102 may have the capacity to understand and/or process the information directly from the reading device 110 and the sensing device 111. However, the system may not include the computing resources to process large amounts of raw information. The system receiving the information may understand and process the converted information from the virtualization module 102 much more quickly and accurately than it could process raw information. For example, in a large warehouse, trucks with huge volumes of inventory may pass through a door constantly. Each truck may be carrying hundreds or even thousands of RFID tagged objects. Many reading devices and sensing devices may be used to track the RFID tagged objects. However, the large volume of information may overwhelm the tracking software such that it fails to function properly. By pre-processing the raw information, such as determining the states of the RFID tagged objects, the software may be capable of tracking the large volume of RFID tagged objects.

For example the host 101 may contain application software 103 for monitoring and tracking inventory. This tracking software 103 may be unable to process information coming directly from reading device 110 and sensing device 111. Inventory tracking software may only take as input predetermined values representing the state for the tagged object 114, such as an “Entry” or “Exit.”

In this example, the tracking software receives the information only as entry into a dedicated entry point or exit from a dedicated exit point. The tracking software is unaware that the sensing device 111 and the reading device 110 are monitoring a single point where tagged objects 114 are passing in multiple directions. The tracking software receives data as if the system is monitoring a dedicated entry point and dedicated exit point, where tagged objects 114 are only entering or exiting. The predetermined values received by the software 103 is easier for it to process and increases the speed and accuracy of the system.

An example is described to further illustrate the embodiments. The system may be used to monitor and/or track inventory. For example, consumer products and goods may be physically associated with one or more RFID tags. The tag may contain information about the goods, including identification information. The inventory may contain a single tag, such as a tag for a palette of goods or may have a plurality of tags, such as a tag for each good.

The tagged goods may be loaded on a transportation means. The transportation means may include any system capable of transporting inventory from one location to another. Transportation means may be as small as a conveyor belt or a single person carrying a product or as large as freight ship. For example, transportation means may include, but are not limited to, a vehicle, such as a car or truck, an airplane, a ship, a train, or an assembly line.

In an embodiment the RFID monitoring system may be mounted at a specific point wherein the RFID tagged inventory passes within the vicinity of the reading and sensing devices. The system may automatically read the RFID tags when a tagged object passes by. For example, the monitoring system is mounted over a docking entrance into a warehouse where trucks load and unload goods from the warehouse. The system reads the tagged goods carried into the truck as the goods pass through the door and reads tagged goods carried out of the truck as the goods pass through the door. When tags are read, the virtualization module 102 may receive the tag information from the reading device 110. The virtualization module 102 also receives state information from the sensing device 111. In this example, the sensing device 111 provides the virtualization module 102 with directional information, such as which IR beams were broken and the order and/or times they were broken. With this directional information the virtualization module 102 determines the direction the goods are moving. The virtualization module 102 then converts the direction to a predetermined value such as entering or exiting a warehouse from the truck. The software 103, which may include an inventory and tracking software application, tracks goods using the predetermined values. For example, palette A is stored as “Exited” from the truck and palettes B and C are stored as “Entered” into the truck. Thus, a driver needing to carry palettes A-C on the truck may be notified by the software 103 which palettes have entered and exited the truck before leaving, and this information may be used by the driver to minimize inadvertently forgetting to load palettes on the truck.

As stated above, the virtualization module 102 may actively query the sensing device 111 for state information. However, information may also be received by the virtualization module 102 from the sensing device 111 automatically, when an object is sensed. Similarly, the reading device 110 may automatically send data to the virtualization module 102 when an RFID tagged object is detected and read. In other embodiments, the virtualization module 102 may actively query the reading device 110 to determine if a tagged object is within the vicinity of the reading device 110.

In on embodiment, the reading device 110, the sensing device 111, and the virtualization module 102 may be configured into a monitoring system, wherein the reading device 110, the sensing device 111, and the virtualization module 102 are all modular components. The reading device 110 and sensing devices 111 may be mounted in appropriate positions around a point 200. The system may be setup by simply plugging-in cables connected between the various components. In another embodiment, the components of the system may send and receive information completely wirelessly. In this embodiment the components may communicate with each other without the need to physically connect them with cable or wires. Of course, in other embodiments, some components may be connected while others in the same system communicate wirelessly.

In some embodiments, the components may be located in the same geographic location. In other embodiments, the virtualization module and/or host 101 may be located in a remote geographic location from the reading device 110 and sensing device 111. For example the reading device 110 and sensing device 111 may be located to monitor a point and then send information to a remote data center where it is processed by the virtualization module and/or host. In other embodiments, the virtualization module 102 may be located in closer proximity to the reading device 110 and sensing device 111. The virtualization module 102 may also be incorporated into either the reading device 110 or the sensing device 111.

In FIGS. 2A-B, the virtualization module 102, for example, generates data representative of a dedicated entry point and a dedicated exit point. The virtualization module 102 may be used to generate data for virtual models other than direction models. For example, the virtual module 102 may generate data from state information representative of virtual doorway or virtual point dedicated to objects of a particular size, such as a virtual doorway that only lets large objects pass through or small objects pass through. In another example, the virtual doorway or virtual point only lets human pass through and another virtual doorway only lets goods pass through. Thus, the virtualization module 102 may determine states from state information for virtual models other than dedicated exit and entry points and the states may be converted to predetermined values and assigned to objects as described above.

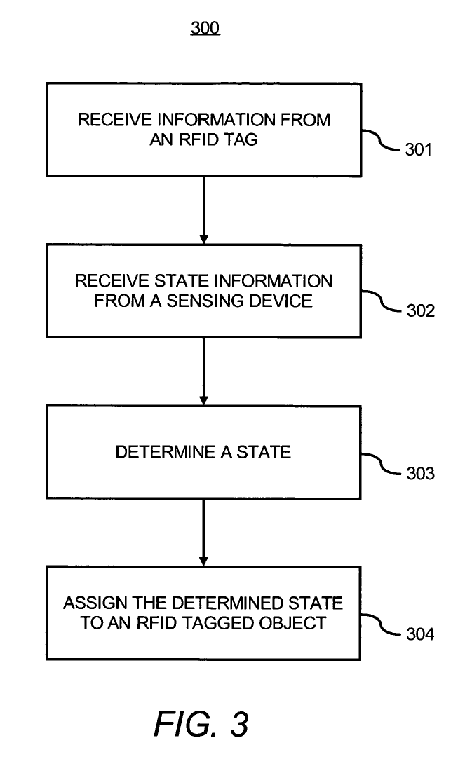

FIG. 3 illustrates a flow chart of a method 300 according to an embodiment. The method 300 is described with respect to FIGS. 1-2 by way of example and not limitation and it will be apparent that the method 300 my be used in other systems.

At step 301, the virtualization module 102 receives information read from the RFID tag 112 of the tagged object 114 shown in FIG. 1. The RFID information may be read from the RFID tag 112 by the reading device 110. Such RFID reading devices are known in the art. At step 302, the virtualization module 102 receives state information about the tagged object 114 from the sensing device 111. At step 303, the virtualization module 102 determines a state for the tagged object 114. The state is determined using the sensed information obtained from the sensing device 111. At step 304, the virtualization module 102 assigns the state to the tagged object 114.

The virtualization module 102 may also convert the state to a predetermined value, such as a predetermined value understood by the software 103. The virtualization module 102 may assign the state or the predetermined value to the tagged object 114.

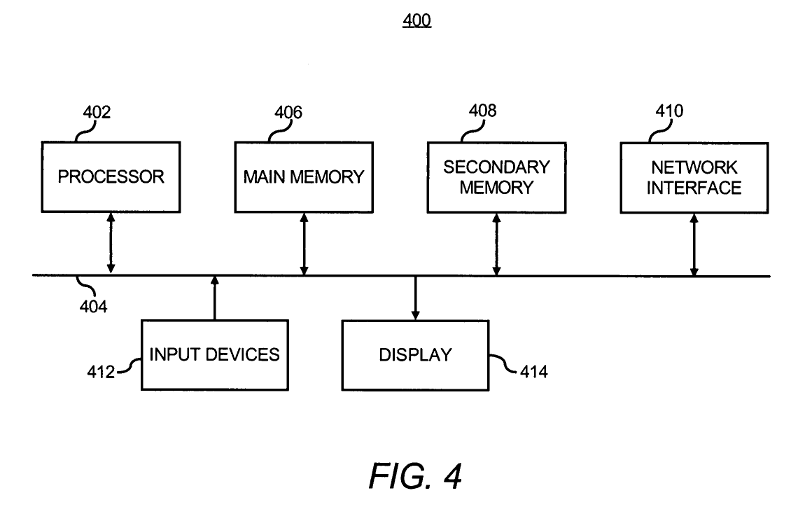

FIG. 4 illustrates a block diagram of a general purpose computer system 400 that is operable to be used as a platform for the virtualization module 102. It will be apparent to one of ordinary skill in the art that a more sophisticated computer system is operable to be used. Furthermore, components can be added or removed from the computer system 400 to provide the desired functionality.

The computer system 400 includes one or more processors, such as processor 402, providing an execution platform for executing software. Commands and data from the processor 402 are communicated over a communication bus 404. The computer system 400 also includes a main memory 406, such as a Random Access Memory (RAM), where software is resident during runtime, and a secondary memory 408. The secondary memory 408 includes, for example, a hard disk drive and/or a removable storage drive representing a floppy diskette drive, a magnetic tape drive, a compact disk drive, etc., or a nonvolatile memory where a copy of the software is stored. In one example, the secondary memory 408 also includes ROM (read only memory), EPROM (erasable, programmable ROM), EEPROM (electrically erasable, programmable ROM). The computer system 400 includes a display 614 and user interfaces comprising one or more input devices 412, such as a keyboard, a mouse, a stylus, and the like. However, the input devices 412 and the display 414 are optional as well as other shown components. A network interface 410 is provided for communicating with other computer systems.

One or more of the steps of the method 300 and other steps described herein are operable to be implemented as software stored on a computer readable medium, such as the memory 406 and/or 408, and executed on the computer system 400, for example, by the processor 402. In one embodiment, the modules shown in FIGS. 1 and 2 include software stored on and executed by the computer system 400.

The steps are operable to be embodied by a computer program, which can exist in a variety of forms both active and inactive. For example, they exist as software program(s) comprised of program instructions in source code, object code, executable code or other formats for performing some of the steps. Any of the above can be embodied on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated below may be performed by any electronic device capable of executing the above-described functions.

While the embodiments have been described with reference to examples, those skilled in the art will be able to make various modifications to the described embodiments without departing from the true spirit and scope. The terms and descriptions used herein are set forth by way of illustration only and are not meant as limitations. In particular, although the methods have been described by examples, steps of the methods may be performed in different orders than illustrated or simultaneously. Those skilled in the art will recognize that these and other variations are possible within the spirit and scope as defined in the following claims and their equivalents.

What is claimed is:

1. A method comprising:
receiving information from at least one RFID tag reading device, wherein the information is read from an RFID tag by the at least one RFID tag reading device and the RFID tag is associated with an object;
receiving state information from at least one sensing device;
determining a state for the object, wherein the state is determined from the state information received from the at least one sensing device; and
assigning the determined state to the object using the information received from the at least one RFID tag reading device.

2. The method of claim 1, wherein assigning the determined state to the object further comprises:
using a virtualization module to determine the state for the object from the received state information, to assign the state to the object, and to convert the assigned state for the object into a predetermined value representing the assigned state of the object.

3. The method of claim 2, wherein the virtualization module is operable to simulate the use of multiple RFID tag reading devices to determine different states for the object.

4. The method of claim 1, wherein the at least one sensing device and the at least one RFID tag reading device are configured to monitor a single point, and wherein the determined state represents a direction of movement through the single point, the method further comprising:
converting the determined state into a predetermined value, wherein the predetermined value is selected from one of entry into a dedicated virtual entry point or exit from a dedicated virtual exit point.

5. The method of claim 4, wherein the object is included in inventory; the method further comprising:
tracking the inventory using the at least one sensing device and the at least one RFID tag reading device.

6. The method of claim 5, wherein tracking the inventory further comprises:
using inventory tracking software to track the inventory, wherein the inventory tracking software receives information obtained from the at least one RFID tag reading device and the at least one sensing device in the form of the predetermined values derived by a virtualization module and understood by the inventory tracking software.

7. The method of claim 1, wherein the state for the object comprises at least one of a determination that the object is a predetermined size, a determination that the object is a good, and a determination that the object is a human.

8. A system comprising:
at least one sensing device operable to sense state information for an object;
at least one reading device operable to read the information contained in an RFID tag associated with the object; and
a virtualization module operable to determine a state for the object from the state information and convert the state to a predetermined value used as data input for an RFID software application.

9. The system of claim 8, wherein the RFID software application comprises:
tracking software operable to track RFID tagged objects read by the at least one reading device and sensed by the at least one sensing device.

10. The system of claim 9, wherein the virtualization module is further operable to assign the determined state to the object using the information read from the RFID tag, wherein the state is represented as a virtual model.

11. The system of claim 8, wherein the at least one sensing device is operable to sense both motion and direction of motion.

12. The system of claim 8, wherein the at least one sensing device comprises at least one of a camera system, an infra red system, and a pressure sensing system.

13. The system of claim 8, further comprising:
a plurality of objects each having an RFID tag, wherein the at least one sensing device is operable to sense directional information for the plurality of objects and the virtualization module is operable to determine a state for each of the plurality objects from the directional information for the object; and
a host operable to receive the states of the plurality of objects and further operable to monitor the plurality of objects based on the states.

14. The system of claim 13, wherein the host is operable to monitor the plurality of objects entering and exiting a location.

15. The system of claim 13, wherein the host is operable to store whether the plurality objects have entered or exited the location.

16. The system of claim 15, wherein the location comprises a single point where the plurality of objects are operable to enter or exit and the virtualization module is operable to represent the single point as a dedicated virtual entry point and a dedicated virtual exit point for the location.

17. The system of claim 8, wherein the state of the object comprises at least one of a determination that the object is a predetermined size, a determination that the object is a good, and a determination that the object is a human.

18. An entry/exit point comprising:
at least one sensing device;
at least one reading device operable to read the information contained in an RFID tag, wherein the RFID tag is associated with an object; and
a computing device operable to determine a state for the object from the information received from the sensing device; further operable to assign the determined state to the object; and further operable to convert the assigned state of the object into a predetermined value, wherein the predetermined value represents the object passing through one of multiple virtual points.

19. The entry/exit point of claim 18, wherein the predetermined value is one of entry into a dedicated virtual entry point and exit from a dedicated virtual exit point.

20. The entry/exit point of claim 18, wherein the predetermined value comprises at least one of entry into a dedicated virtual entry point only for objects of a predetermined size, entry into a dedicated virtual entry point only for objects that are goods, and entry into a dedicated virtual entry point only for objects that are humans.

21. A computer readable medium upon which is stored a computer program including instructions which when executed by a processor cause the processor to perform the following steps, wherein the steps comprise:
receiving information from at least one reading device, wherein the information includes identification information from an RFID tag, wherein the RFID tag is associated with an object;
receiving state information from at least one sensing device;
determining a state from the state information;
assigning the determined state to the object; and
converting the determined state into a predetermined value.

22. The computer readable medium of claim 21, further comprising:
tracking the movement of the object, wherein the movement of the object is tracked with the predetermined value.

23. The computer readable medium of claim 22, wherein the virtualization module is operable to simulate virtual reading devices.
